(19) United States
(12) Patent Application Publication
(10) Pub. No.: US 2005/0272433 A1
(43) Pub. Date: Dec. 8, 2005

(54) Cell configuration method and system with minimum intercell interference and method for channel allocation therein

(75) Inventors: Jong-Hyun Won, Seoul (KR); Yun-Sang Park, Suwon-si (KR); Jae-Hwan Chang, Suwon-si (KR); Tae-In Hyon, Hwaseong-si (KR); Yun-Sung Kim, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/031,209

(22) Filed: Jan. 7, 2005

(30) Foreign Application Priority Data
Jun. 4, 2004 (KR) 10-2004-0040774

(51) Int. Cl. H04Q 7/20

(52) U.S. Cl. 455/449; 455/446

(57) ABSTRACT

A cell configuration method and system and a channel allocation method for the system are disclosed for minimizing the influence of intercell interference between cells in a mobile communication system capable of providing a mobile subscriber with a stable communication service, by determining a number of safety channels to be assigned to each of the plurality of cells, and providing the adjacent cells around the serving cell with at least one additional shared safety channel other than the safety channel originally assigned to the each cell.

### CLAIM OF PRIORITY

This application claims benefit under 35 U.S.C. §119 from an application entitled “A Method And System With Cell Configuration For Minimizing Intercell Interference And A Method For Channel Allocation Therein” earlier filed in the Korean Industrial Property Office on Jun. 4, 2004 and assigned Serial No. 2004-40774, the contents of which are hereby incorporated by reference.

### BACKGROUND OF THE INVENTION

1. Field of the Invention

The present invention relates generally to cell configuration and channel allocation with a minimum of intercell interference in a mobile communication system, and in particular, to a method and system configured to provide a mobile subscriber located at a cell boundary with a more stable communication service with a reduction of intercell interference by an adjacent cell and such a channel allocation method used therein.

2. Description of the Related Art

Mobile Internet communication systems are generally configured of a cellular network, so that a respective terminal for a mobile subscriber may communicate with another terminal or a server connected to a mobile communication network through a nearest base station (BS). Cellular networks usually adopt a frequency reuse scheme in which all the other cells utilize a same frequency simultaneously, for effecting the maximum efficiency in the use of frequency. According to a current Broadband Wireless Access (BWA) system, it is generally stipulated that the reuse of frequency shall be made in all cells in a network for a maximum efficiency in frequency use. In the case where a frequency reuse factor is 1 in such a BWA system, mobile terminals located at a cell boundary are often significantly affected by intercell interference from their adjacent cells, so that Signal-to-Noise-and-Interference Ratio (SNIR) becomes too low, thereby making it difficult to provide those terminals with associated links to communicate with other terminals or servers without such interference.

As such, with a goal to minimize the interference from adjacent cells when mobile terminals are located at a cell boundary, the cells of BWA system are configured to have safety channels. A safety channel is a reserved bin having no traffic transfer within its own cell for adjacent cells, for not only reducing the intercell interference induced by adjacent cells, but also minimizing the interference from the adjacent cells for those terminals located at the cell boundary. A bin is set of 9 contiguous subcarriers within an OFDMA symbol, and is a basic allocation unit both in the downlink and the uplink. A base station of each cell is assigned N reserved bins for the safety channel and the positions of those bins for the safety channel are configured differently from cell to cell. Thus, the safety channel allocated in each cell is generally set up in a different frequency band from that of other cells.

FIG. 1 shows an example of cell structure adapted in a conventional mobile communication system, which may be referred to as a cellular communication system for mobile radio telecommunications based on OFDMA (Oithogonal Frequency Division Multiple Access) system. The overall system is generally provided with a plurality of base stations 100, 102 and 104, each base station covering its own respective cell 10, 20 and 30. Although there are shown only three base stations and cells in FIG. 1 by way of example, the mobile communication system may be configured with more than three base stations and associated cells, as is common in many commercial application systems.

A mobile communication terminal 110 scans a safety channel when a carrier to interference (C/I) ratio of a serving cell 10 is not higher than the C/I ratio of a target cell 20 by a predetermined value, with respect to several frames received. The respective base station makes a puncturing in advance for sub-carriers corresponding to the second preamble of the two preambles of the OFDMA symbols in one frame so that the terminal is allowed to scan the safety channel.

FIGS. 2A and 2B illustrate a set of frame data generally received by the terminal from the base station. FIG. 2A shows the frame data received from the serving cell 10, while FIG. 2B shows the frame data received from the target cell 20.

The terminal 110 compares a first downlink preamble of the serving cell 10 with a second downlink preamble so that the first downlink preamble recognizes bins on or above a predetermined value as a safety channel of the target cell 20. Then, the terminal 110 informs the base station 100 in the serving cell 10 of an index of bins pertaining to the searched safety channel and requests the base station to assign some of these bins. Once those bins have been assigned from the base station 100, the terminal makes a use of the bins. After that, when the Carrier to Interference (C/I) ratio of the serving cell 10 is greater than the C/I ratio of the target cell 20 by a predetermined value, the use of the safety channel is terminated.

In the above-described cell construction, only the interference from an adjacent single cell is usually considered, so it is appreciated that it may be very difficult for the terminal to effectively deal with the problems caused when the mobile terminal is located at the boundaries of three adjacent cells or such a primary interference is exerted from the two adjacent cells. For instance, when the terminal 112 is located in a substantially overlapped area of three cells 10, 20 and 30 including the serving cell itself, the mobile terminal may be able to avoid any adverse interference from the first adjacent cell 20 by means of requesting the safety channel of the base station 102 in the first adjacent cell 20 to the base station 100 of the serving cell 10 and then assignment of that safety channel. However, even in this occasion, the terminal 112 may be still unable to avoid such interference from the second adjacent cell 30. Likewise, when the safety channel of the base station 104 in the second adjacent cell 30 has been requested by the base station 100 the serving cell 10 and then assigned of that safety channel, the mobile terminal 112 may be able to avoid any adverse interference from the second adjacent cell 30, but it may be still impossible to avoid the interference from the first adjacent cell 20.

### SUMMARY OF THE INVENTION

As seen in the above description, even when a mobile terminal 112 uses a safety channel assigned by its adjacent cell, it may be substantially impossible for the terminal 112 to remove the interference induced from the remaining adjacent cells, because the base stations 100, 102 and 104 each are assigned safety channels that are different from each other. Further, if the interference from the adjacent cells is at a significant level, then the mobile terminal may be substantially unable to search for a correct safety channel frequency band while scanning preambles punctured in any of the received frames for finding the safety channel.

It is, therefore, an aspect of the present invention to provide a method for cell configuration in a mobile communication system capable of providing a mobile subscriber located at the boundary area between a serving cell and its adjacent cells with a minimum of intercell interference, thereby providing a stable communication service to the subscriber.

It is another aspect of the present invention to provide a channel allocation system capable of providing a mobile subscriber located at the boundary area between a serving cell and its adjacent cells with a minimum of intercell interference, and a method for channel allocation, thereby providing a stable communication service to the subscriber.

It is still another aspect of the present invention to provide a system and method for cell configuration adapted to providing a stable hand-off operation in a mobile communication system and a channel allocation method applicable in the system.

To achieve the above and other aspects of the present invention, there is provided a cell configuration method for minimizing intercell interference between a serving cell for a mobile terminal and adjacent cells of the serving cell in a mobile communication system having a plurality of cells, including the steps of determining a number of safety channels to be assigned to each of the plurality of cells; and providing the adjacent cells around the serving cell with at least one additional shared safety channel other than the safety channel originally assigned to the each cell.

According to a second aspect of the present invention, there is provided a mobile communication system having a serving cell associated with a mobile terminal located in the cell area, the serving cell being assigned a safety channel, and having a plurality of adjacent cells around the serving cell, the adjacent cells each having at least one additional shared safety channel other than the safety channel originally assigned to the serving cell, the system including a base station associated with the serving cell capable of assigning to the mobile terminal at least one shared safety channel other than the safety channel originally assigned to the serving cell, when the base station receives a request for safety channel allocation; and a mobile terminal adapted to send a request for safety channel allocation to the base station in the serving cell, if during communication with the serving cell a level of the intercell interference from the adjacent cells is greater than a predetermined threshold value, and to maintain the communication with the base station through the safety channel assigned by the base station.

According to a third aspect of the present invention, there is provided a method for minimizing the intercell interference between cells in a mobile communication system having a serving cell associated a mobile terminal located in the cell area, the serving cell being assigned with a safety channel, and having a plurality of adjacent cells around the serving cell, the adjacent cells each having at least one additional shared safety channel other than the safety channel originally assigned to the serving cell, including the steps of sending a request for safety channel allocation to a base station of the serving cell in case the intercell interference from the adjacent cell during communication with the serving cell is more than a predetermined threshold value; assigning to the mobile terminal the shared safety channel of the adjacent cells except their own original safety channels, when the base station of the serving cell has received the request for safety channel allocation from the mobile terminal; and wirelessly communicating through the safety channel assigned by the base station.

### BRIEF DESCRIPTION OF THE DRAWINGS

The above and other objects, features and advantages of the present invention will become more apparent from the following detailed description when taken in conjunction with the accompanying drawings in which:

FIG. 1 schematically shows a typical cell configuration in a conventional mobile communication network applied in the present invention;

FIGS. 2A and 2B schematically show a format of frame data received by a mobile terminal from a base station in the mobile communication system;

FIG. 3 schematically shows the improved cell configuration in the mobile communication system according to a preferred embodiment of the present invention;

FIGS. 4A to 4C respectively show safety channels assigned to each cell in the mobile communication system having the cell configuration according to the preferred embodiment of the present invention;

FIGS. 5A to 5B schematically shows the cell configuration in which the safety channels are allocated so as to minimize the intercell interference induced in between adjacent cells in the mobile communication system according to the preferred embodiment of the present invention;

FIG. 6 shows a flow chart diagram of the control sequence for carrying out the optimum channel allocation between the mobile terminal and the base station in the mobile communication system according to a first embodiment of the present invention; and

FIG. 7 shows a flow chart diagram of the control sequence for carrying out the optimum channel allocation between the mobile terminal and the base station in the mobile communication system according to a second embodiment of the present invention.

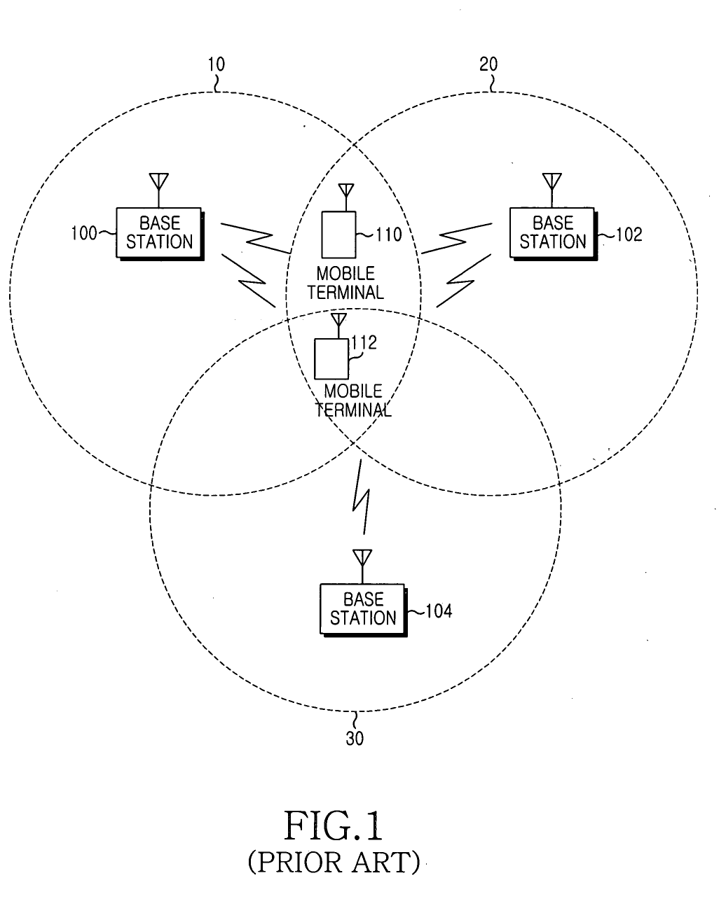

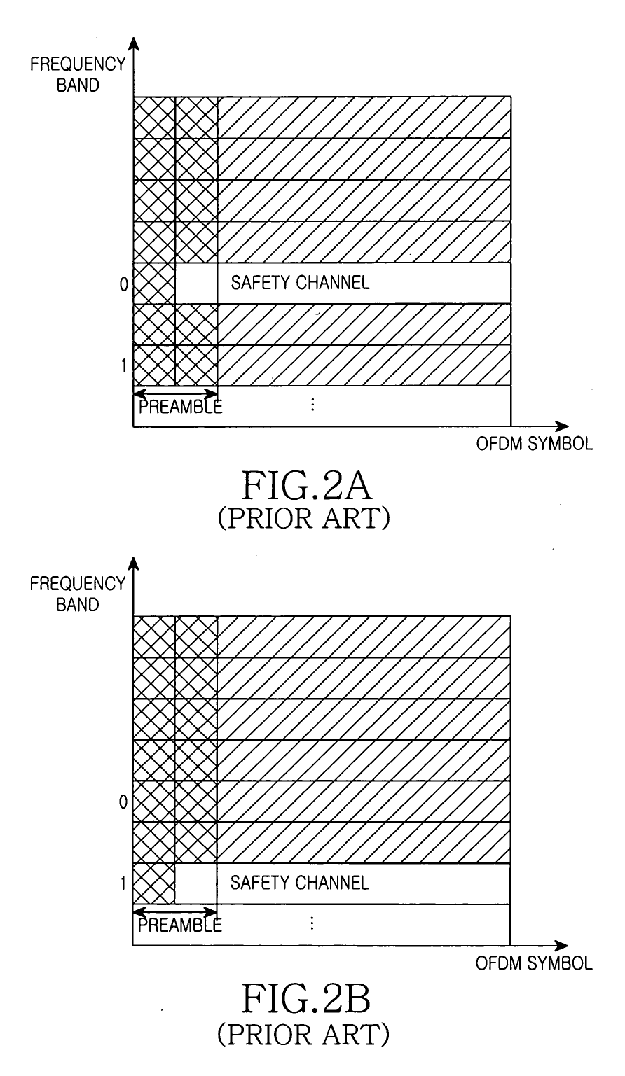

### DETAILED DESCRIPTION OF THE PREFERRED EMBODIMENTS

A preferred embodiment of the present invention will be described hereinafter with reference to the accompanying drawings. In the following description, the same drawing reference numerals are used for the same elements, even in different drawings. A detailed construction and circuit elements are described only to assist in a comprehensive understanding of the invention. Thus, it will be apparent that the present invention can be carried out without these particulars. Also, well-known functions or constructions are not described in detail since they would obscure the invention in unnecessary detail. Furthermore, although many particular details such as circuit components or blocks are to be shown in the following description, they are provided for a better understanding of the invention to the reader by way of example only, but not limited to those details disclosed herein.

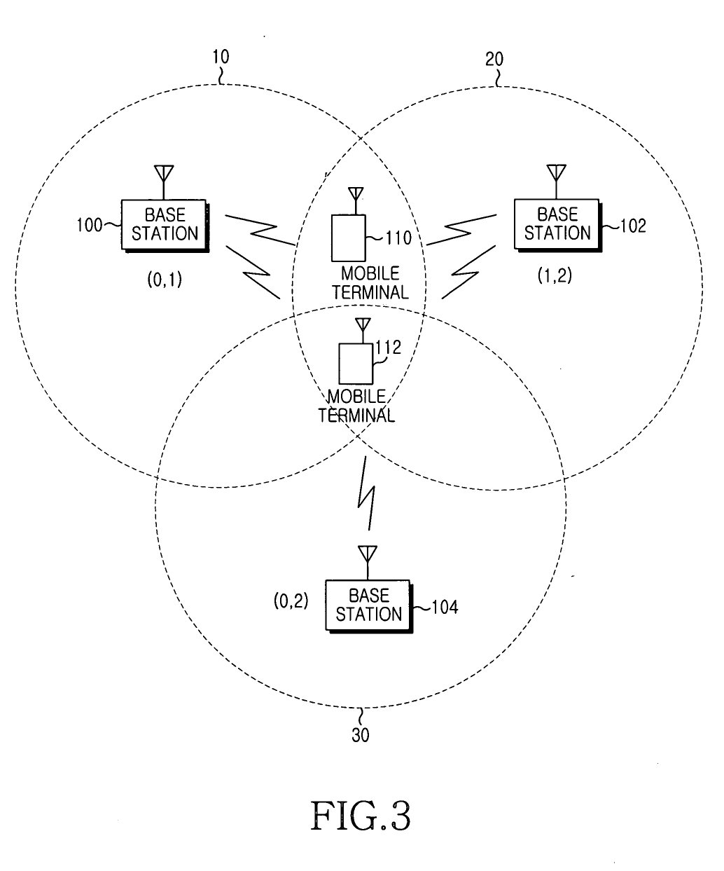

Referring now to FIG. 3, description is made to the improved cell configuration in the mobile communication system according to a preferred embodiment of the present invention. Although a typical mobile communication system consists of a large number of individual cells, the cell configuration in FIG. 3 illustrates only three cells for the sake of convenience in explanation.

The mobile communication system according to the present invention is configured in such a way that a respective base station 100, 102 and 104 in each cell 10, 20 and 30 is provided with a fixed number of safety channels, in which the each base station 100, 102 and 104 usually assigns 3×n bins for the safety channels of a communication bandwidth, wherein “n” is a given integer. These bins may consist of at least three sets of bins, each set having one or more bins, wherein those sets of bins are allocated to different frequency bands. In this embodiment of the invention, the safety channels in the sets of bins with the different frequency bands are indicated by symbols 0, 1 and 2, by way of example. Each cell is assigned two safety channels of the three safety channels so that any one cell is overlapped with only one safety channel of its adjacent cell.

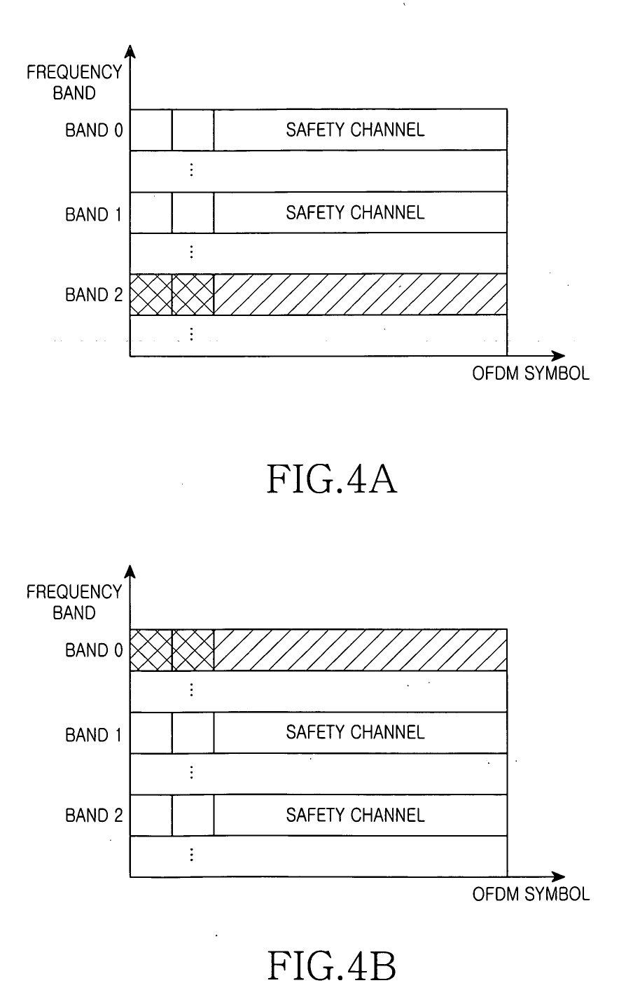

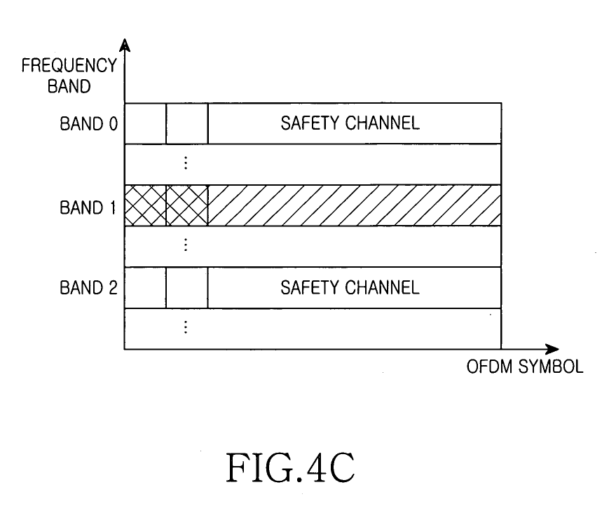

Referring then to FIGS. 4A to 4C, a more detailed description is made to the safety channels assigned to the base stations with the cell configuration, as described with reference to FIG. 3, in each cell 10, 20 and 30 in the mobile communication system with the cell configuration according to the preferred embodiment of the present invention.

Base station 100 of cell 10 is assigned frequency bands 0 and 1 for the safety channels, as seen in FIG. 4A, while in the base station 102 of the cell 20 the frequency bands 1 and 2 are assigned for the safety channels, as seen in FIG. 4B, and similarly, in the base station 104 of the cell 30 the frequency bands 0 and 2 are assigned for the safety channels, as seen in FIG. 4C. As such, the two cells 20 and 30 located adjacent to the cell 10 are provided with either one of safety channels 0 and 1 assigned to the base station 100 of the cell 10 and provided in common with the safety channel 2. According to the embodiment of the invention, any adjacent cells of a reference cell are assigned a pair of two safety channels, one of them being overlapped with those of the reference cell and the other not being overlapped with those of the reference cell.

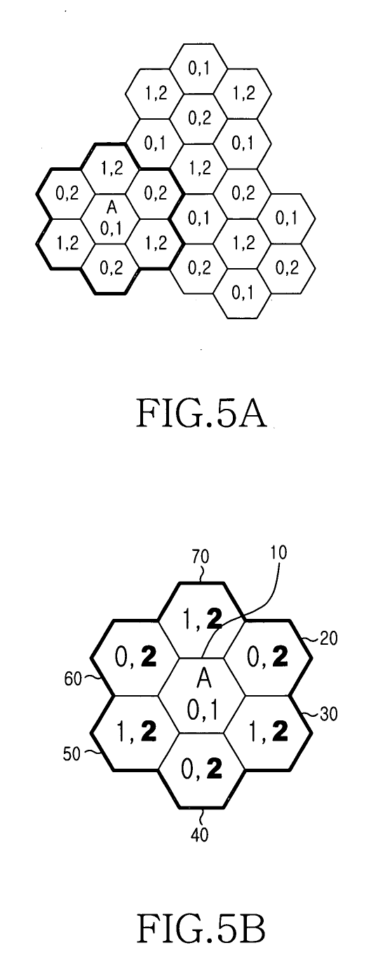

Referring to FIG. 5A, a method of safety channel allocation for adjacent cells around a serving cell A is illustrated, by way of an example, using the basic cell configuration according to the invention. Within a typical cell area enveloped in a bold line, the serving cell A is assigned with the safety channels 0 and 1, while its adjacent cells surrounding the serving cell A are assigned with either one of those safety channels 0 and 1, and with the common safety channel 2. Hence, it is appreciated that the cell configuration is arranged so that every cell overlaps only one safety channel with its adjacent cells, as seen in FIG. 5B more clearly.

Hereinafter, the operation in the base station for a channel allocation from a serving cell to a mobile terminal will be described in accordance with the aforementioned cell configuration. Once the base station in the serving cell 10 receives a request for safety channel allocation from the mobile terminals 110 and 112, the base station 100 assigns to mobile terminals 110 and 112 bins of the safety channel 2 that is not retained by itself. Further, if the reported Carrier to Interference ratio (C/I) is not less than a specified threshold value, then a channel other than the safety channel is assigned.

In the meantime, if the mobile terminals 110 and 112 are communicating with each other using the cell as a serving cell, at least one of them enters into a boundary area between the serving cell 10 and its adjacent cells 20 and 30 to force the C/I value to go down below the specified threshold level, then the C/I value is to be reported to the base station 100 of the serving cell 10 to make a request for safety channel allocation. Then, once the allocation of the safety channel from the base station 100 has been made, the mobile terminals are controlled to maintain their communication channel through the allocated safety channel and subsequently, if the C/I value becomes greater than the specified threshold value, the base station discontinues the safety channels concerned. At this moment of operation, the mobile terminals 110 and 112 check the C/I values and, on a periodical basis, compare the C/I with the specified threshold value for determining the relation to the level of interference from those adjacent cells, consequently reporting the result of comparison to the base station.

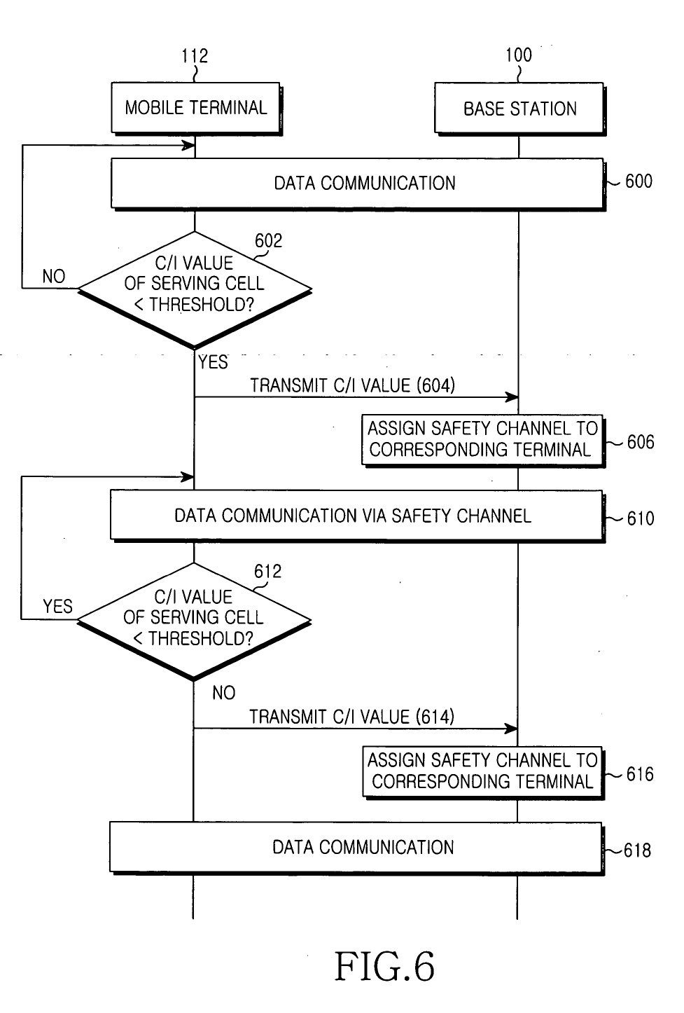

Now, referring to FIG. 6, a description is made of the control sequence for carrying out with the least possible interference from any adjacent cells to a mobile terminal located at a cell boundary area in the mobile communication system with the aforementioned cell configuration. FIG. 6 shows a flow chart diagram for controlling the channel allocation between the mobile terminal and the base station in accordance with the first embodiment of the present invention. The mobile terminal is assumed to be terminal 112 affected by the interference applied from three cells as shown in FIG. 3, but the operation will be the same for terminal 110.

While the mobile terminal 112 is communicating with the base station 100 of the serving cell 10 in step 600, the Carrier to Interference (C/I) value in the serving cell 10 is checked in step 602 to determine if it is not greater than a specified threshold value. Thereafter, if it is not greater than the threshold value, then the mobile terminal 112 transmits the C/I value to the base station 100 with a view to making a request for safety channel allocation in step 604 to prevent any interference from the adjacent cells during communication. In step 606, the base station 100 having received this C/I value assigns to the mobile terminal 112 a few of bins of the safety channel band other than the safety channels retained by the base station itself.

Referring again to FIG. 5B, a detailed description will be made to the safety channel allocation from the mobile terminal 112 in the base station 100. First of all, the safety channels 0 and 1 are assigned to the serving cell 10, while the identical safety channel 2 other than those safety channels of the serving cell 10 is assigned to the adjacent cells 20 to 70. If the C/I value measured by the mobile terminal 112 is not greater than the specified threshold value, then the base station 100 assigns to the mobile terminal 112 the safety channel 2 in a frequency band not occupied by the adjacent cells, thereby carrying out a channel allocation so that no interference from the adjacent cells is made to the mobile terminal 112. As all the adjacent cells surrounding the serving cell 10 are configured to have the safety channel 2 in common, the mobile terminal will not be necessary to inspect the preambles of received frames for searching for a safety channel, as in the prior art, but it will be only enough to make a request for safety channel allocation to the base station.

As understood from the above description, the safety channel assigned by the base station is incorporated into UL-MAP (uplink map) or DL-MAP (downlink map) for transmission to the mobile terminal 112, and the mobile terminal 112 carries out data communication with the base station 100 through the assigned safety channel, in step 610. Hence, at this stage, the mobile terminal 112 performs the wireless communication with the base station without any interference from those adjacent cells, since it carries out the wireless communication through the safety channel 2 that is of the frequency band not occupied by any mobile terminals in those adjacent cells. If it is determined in step 612 that the C/I value of the serving cell 10 is not less than the specified threshold value with respect to the received frames, then the mobile terminal 112 transmits the C/I value to the base station in step 614, thereby requesting the termination of the safety channel. Accordingly, the base station 100 recognizes in step 616 that it will not be necessary for the mobile terminal 112 to use any safety channels because the interference from the adjacent cells is at a critical level, and it assigns to the corresponding mobile terminal a fresh common data channel other than the safety channel. Such an assigned data channel is transmitted to the mobile terminal via UL-MAP or DL-MAP, and the mobile terminal 112 having received this channel continues to communicate with the base station 100 via the assigned channel. Further, if the C/I value is not less than the threshold value in step 616, then an operation sequence may be carried out that the safety channel is terminated and a fresh channel assigned, or alternatively, another operation sequence may be implemented so that while the safety channel is maintained, a fresh channel is assigned and upon completion of setup, the safety channel is terminated.

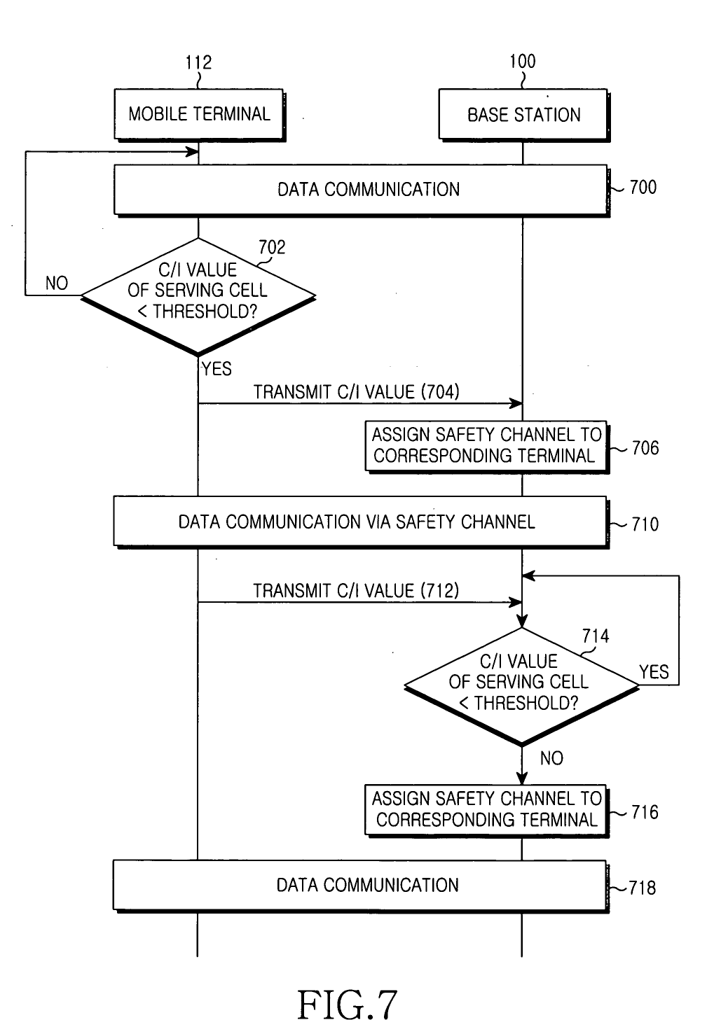

Referring now to FIG. 7, the control sequence for carrying out the optimum channel allocation between the mobile terminal and the base station in the mobile communication system according to the second embodiment of the present invention will be described.

While the mobile terminal 112 is communicating with the base station 100 of the serving cell 10 in step 700, the C/I value of the serving cell 10 is checked in step 702 to determine if it is less than a specified threshold value. Thereafter, if it is not greater than the threshold value, the C/I value is transmitted to the base station 100 in step 704 in order to request a channel allocation. The mobile terminal 112 transmits the C/I value to the base station 100 to make a request for safety channel allocation to prevent any interference from the adjacent cells during communication. In step 706, the base station 100 having received this C/I value assigns to the mobile terminal 112 bins of the safety channel band other than the safety channels retained by the base station itself. Subsequently, the mobile terminal 112 carries out data communication with the base station 100 through the assigned safety channel, in step 710. Then, the mobile terminal 112 makes a periodic measurement on the C/I values with respect to the received frames in step 712 and transmits the measured value to the base station. If it is determined in step 714 that the received C/I value is not less than the specified threshold value with respect to the received frames, then the control proceeds to step 716 to terminate the safety channel and then assign to the mobile terminal 112 a fresh channel for the data communication other than the aforementioned safety channel. As an alternative, the control sequence may be implemented so that in step 716, when the received C/I value is greater than the specified threshold value with respect to the received frames, the safety channel is maintained and a new channel is assigned, thereby terminating the safety channel upon completion of the setup for channel allocation. As seen in the foregoing description, the timing sequence of channel termination and channel allocation for a safety channel may be changed, provided that the wireless communication between the mobile terminals and the base station can be fulfilled in a smooth and efficient manner.

Such an assigned data channel is transmitted to the mobile terminal 112 via UL-MAP or DL-MAP, and the mobile terminal 112 having received this channel continues to communicate with the base station 100 via the assigned channel, in step 718.

As understood from the foregoing, the mobile communication system according to the present invention is configured so that any adjacent cells around a reference cell are assigned with the identical safety channel, in common, different from a safety channel assigned to a base station in the reference cell, so the system is subject to less interference from those adjacent cells, assigning to a mobile subscriber terminal located in the cell boundary area the safety channel assigned in common to the adjacent cells except for a serving cell.

As apparent from the foregoing description, the present invention can eliminate the interference induced by all the adjacent cells except for the serving cell. Furthermore, the system according to the invention has an advantage in that when a mobile terminal sends a request for a safety channel allocation to a base station, without any need for separately performing a scanning operation to look for an extra safety channel, the base station of the serving cell having received this request assigns to the mobile terminal a remaining safety channel except for its own safety channel, therefore improving complexity in the system construction. As such, in the case of assignment of safety channels in advance, sub-carriers used by the user terminals located in the cell boundary area are in frequency band not occupied by any adjacent cells, so a boosting of its transmission power can be accomplished. Moreover, the present invention also improves the link power margin required for formation of a wireless link in the cell boundary area, which will essentially leads to remarkable improvements in the hand-off performance of a mobile terminal as well as the wireless transmitting and receiving performance thereof.

While the present invention has been heretofore shown and described with reference to preferred embodiments, it will be understood by those skilled in the art that various changes and modifications in form and details may be made therein and the equivalents may be substituted for elements thereof, without departing from the spirit and scope of the invention as defined by the appended claims.

1. A method for minimizing intercell interference in a mobile terminal between a serving cell and cells adjacent to the serving cell in a mobile communication system having a plurality of cells, the method comprising the steps of:
determining a number of safety channels to be assigned to each of the plurality of cells; and
providing the cells adjacent to the serving cell with at least one common safety channel other than the safety channel originally assigned to the each cell.

2. A mobile communication system having a serving cell associated with a mobile terminal located in the cell area, the serving cell assigned a safety channel, and having a plurality of cells adjacent to the serving cell, the adjacent cells each having at least one additional shared safety channel other than the safety channel originally assigned to the serving cell, the system comprising:
a base station associated with the serving cell, for assigning the mobile terminal at least one shared safety channel other than the safety channel originally assigned to the serving cell, when the base station receives a request for safety channel allocation; and
a mobile terminal adapted to send a request for a safety channel allocation to the base station in the serving cell, if during communication with the serving cell a level of the intercell interference from the adjacent cells is greater than a predetermined threshold value.

3. The mobile communication system according to claim 2, wherein the base station terminates the assigned safety channel if the base station receives a request for termination of safety channel from the mobile terminal.

4. The mobile communication system according to claim 2, wherein the mobile terminal checks a Carrier to Interference (C/I) value of received signals on a periodical basis and compares the C/I value with a threshold value to determine the level of an intercell interference, so that if the C/I value goes down below the threshold value, then the mobile terminal reports the measured C/I value to the base station to request a safety channel allocation.

5. The mobile communication system according to claim 4, wherein if it is determined that the C/I value is greater than the threshold value while communicating on the mobile terminal through the assigned safety channel, the mobile terminal determines that the intercell interference from the adjacent cells is not at a critical level and then reports the measured C/I value to the base station to request a termination of the safety channel.

6. The mobile communication system according to claim 2, wherein the mobile terminal reports a Carrier to Interference (C/I) value of received signals on a periodical basis to the base station, while communicating on the mobile terminal through the safety channel assigned by the base station.

7. The mobile communication system according to claim 6, wherein if it is determined that the C/I value received from the mobile terminal is greater than the threshold value, the base station terminates the assigned safety channel.

8. A method for minimizing intercell interference between cells in a mobile communication system having a serving cell associated with a mobile terminal located in the cell area, the serving cell assigned a safety channel, and having a plurality of cells adjacent to the serving cell, the adjacent cells each having at least one additional shared safety channel other than the safety channel originally assigned to the serving cell, the method comprising the steps of:
sending a request for safety channel allocation to a base station of the serving cell when intercell interference from a cell adjacent to the service cell during communication with the serving cell is greater than a predetermined threshold value;
assigning to the mobile terminal the shared safety channel of the adjacent cells in addition to the its own original safety channel, when the base station of the serving cell has received the request for safety channel allocation from the mobile terminal; and
communicating through the safety channel assigned by the base station.

9. The method according to claim 8, further comprising the step of checking in the mobile terminal a Carrier to Interference (C/I) value of received signals on a periodical basis for comparing of the C/I value with the threshold value to determine a level of intercell interference, so that if the C/I value is less than the threshold value, then the mobile terminal reports the measured C/I value to the base station to request a safety channel allocation.

10. The method according to claim 9, further comprising the step in which if it is determined that the C/I value is greater than the threshold value while communicating on the mobile terminal through the assigned safety channel, the mobile terminal determines that the intercell interference from the adjacent cells is not at a critical level and then reports the measured C/I value to the base station to request a termination of the safety channel.

11. The method according to claim 10, further comprising the step of terminating in the base station the assigned safety channel, when the base station receives a request for termination of safety channel from the mobile terminal.

12. The method according to claim 10, further comprising the step of reporting the C/I value of received signals, on a periodical basis, to the base station from the mobile terminal, while communicating on the mobile terminal through the safety channel assigned by the base station.

13. The method according to claim 12, further comprising the step of terminating the assigned safety channel if it is determined that the C/I value received from the mobile terminal is greater than the threshold value.

14. The method according to claim 12, further comprising the step of assigning a new data channel by the base station when the C/I value received from the mobile terminal is greater than the threshold value.

15. The method according to claim 14, further comprising the step of terminating the assigned safety channel under control of the base station subsequently to assignment of the new data channel.
